(19) United States
(12) Patent Application Publication
(10) Pub. No.: US 2020/0093238 A1
(43) Pub. Date: Mar. 26, 2020

(54) MOBILE PHONE CASE HAVING MIRRORED SURFACE AND LIGHTING

(71) Applicant: Harsh Kumar, Lake Forest, IL (US)

(72) Inventor: Harsh Kumar, Lake Forest, IL (US)

(21) Appl. No.: 16/697,911

(22) Filed: Nov. 27, 2019

Related U.S. Application Data
(63) Continuation-in-part of application No. 15/184,271, filed on Jun. 16, 2016.

(51) Int. Cl. A45C 15/06; H04M 1/02; F21V 23/00; F21V 23/02; F21V 33/00; F21V 23/04; F21L 4/08; A45C 15/04; A45C 11/00

(52) U.S. Cl. CPC A45C 15/06; H04M 1/0266; F21V 23/003; F21V 23/02; F21V 33/0052; F21Y 2115/10; F21V 23/0442; F21L 4/08; A45C 15/04; A45C 11/00; F21V 23/0414

(57) ABSTRACT

A mobile phone case adapted to accommodate a mobile phone device having a mirrored surface attached is disclosed. The mirrored surface is preferably attached to the back side of the phone case. Alternatively, the case may be a folding type case having the phone on one side and the mirrored surface on the other. The phone case attaches substantially to the rear of the mobile phone, and preferably includes openings which align with phone components. A plurality of LEDs are disposed about the perimeter of the mirrored surface, allowing the object of the reflection to be illuminated. The LEDs may derive power from the phone power source or from a separate power source such as one or more button cell or rechargeable batteries. Optionally, the LEDs are dimmable via a control.

### CROSS-REFERENCE TO RELATED APPLICATIONS

This is a continuation-in-part of application Ser. No. 15/184,271, filed Jun. 16, 2016, which is hereby incorporated by reference in its entirety.

### BACKGROUND OF THE INVENTION

### Field of the Invention

The present invention relates to a mobile phone case having a mirrored surface, and more particularly, to a mobile phone case having a mirrored surface surrounded by lighting elements.

### Background

It is common for various individuals to make use of a mirrored surface for numerous purposes. Individuals may use mirrored surfaces to examine the face, apply makeup or other cosmetic products, for personal grooming, or for other purposes. When an individual is away from home, it is often desirable to have a portable mirror for these purposes.

It has become increasingly common for individuals to carry with them a mobile phone device. As a large number of individuals already carry such a device, combining such a device with a mirrored surface would be an efficient way to provide a convenient portable mirror.

Various attempts have been made to address this need. For example, U.S. Pat. No. 6,424,823 discloses a cell phone having a mirror combined with it. However, no sufficient lighting is provided for use of the mirror.

U.S. Pat. No. D712,890 discloses a slotted, mirrored cell phone case. However, sufficient or customizable lighting is not provided.

U.S. Published Application No. 2011/0077061 discloses a phone case in which one must open the case to flip up a mirror. The user must take this step of opening the case to access a mirror. Convenient lighting again is lacking.

While various other devices have been proposed, a mobile phone case having an integrated convenient mirror with effective lighting is a need which remains unmet.

### SUMMARY

The present invention is a mobile phone case having a mirrored surface. The case is adapted to encase at least a portion of a mobile phone. Preferably, the case is of the type that there is a front opening aligned with the viewing screen of the mobile phone, and thus, the majority of the case is on the rear side of the mobile phone. Thus, the mirrored surface is ideally disposed on the rear surface of the case.

The mirrored surface may be formed in any suitable manner, and in any shape or size. Preferably, the mirrored surface has a reflectivity of at least 75% such that it is suitable for a user to view a reflection of the user's face.

In various embodiments, peripheral lighting elements are disposed about or around the perimeter of the mirrored surface. A plurality of LEDs may be included specifically for this purpose. An arrangement of four to six LEDs around the perimeter is particularly suitable to illuminate the face of the user evenly for the purpose of utilizing the mirrored surface.

The lighting elements may use the same power source as the mobile phone, such as the mobile phone battery. Alternatively, the lighting elements may utilize an auxiliary power source such as batteries, optionally in the form of button cell or rechargeable batteries, housed in the case.

The lighting elements are turned on or off via a switch. In certain embodiments, a timer may be used to turn the lighting elements off after a predetermined amount of time after they are turned on, such as 20 or 30 seconds, or any other desired time. Such time may be preset in the system, or the user optionally may have the option of setting this timing.

In certain embodiments, the user will have the option to use a dimmer switch to adjust the lighting elements to the desired degree of illumination. Ideally, the lighting elements are not so bright as to hinder the user or be unpleasant to the user when making use of the mirrored surface.

In other embodiments, a light sensor is included, and the level of illumination may be automatically adjusted in accordance with the amount of ambient light sensed by the sensor.

In various other embodiments, the phone case includes a folding type case having the phone on one side and a mirrored surface on the inside of the cover portion. LED lighting elements around the peripheral region of the mirrored surface are optionally different colors of light, and can be toggled between one or the other, or both. A dimmer optionally controls the brightness level. In certain embodiments, a separate rechargeable battery powers the LED's, and a wireless charging coil is included within the cover portion of the case.

Still other objects and advantages of the present invention will become readily apparent to those skilled in the art from the following detailed description, wherein it is shown and described only the preferred embodiments of the invention, simply by way of illustration of the best mode contemplated of carrying out the invention. As will be realized, the invention is capable of other and different embodiments and its several details are capable of modifications in various obvious respects, without departing from the invention. Accordingly, the drawings, wherein like reference numerals represent like features, and description are to be regarded as illustrative in nature and not as restrictive.

### BRIEF DESCRIPTION OF THE DRAWINGS

FIG. 1 shows a rear view of the mobile phone case having a mirrored surface of one embodiment of the present invention.

FIG. 2 shows a rear view of the mobile phone case having a mirrored surface of another embodiment of the present invention.

FIG. 3 shows a rear view of the mobile phone case having a mirrored surface of another embodiment of the present invention.

FIG. 4 shows a rear view of the mobile phone case having a mirrored surface of another embodiment of the present invention.

FIG. 5 shows a rear view of the mobile phone case having a mirrored surface of another embodiment of the present invention.

FIG. 6 shows a perspective view of the mobile phone case having a mirrored surface of another embodiment of the present invention.

FIG. 7 shows a perspective view of the mobile phone case having a mirrored surface of another embodiment of the present invention.

FIG. 8 shows a perspective view of the mobile phone case having a mirrored surface of another embodiment of the present invention.

FIG. 9 shows a perspective view of the mobile phone case having a mirrored surface of another embodiment of the present invention.

FIG. 10 shows a perspective view of the mobile phone case having a mirrored surface of another embodiment of the present invention.

FIG. 11 shows a perspective view of the mobile phone case having a mirrored surface of another embodiment of the present invention.

FIG. 12 shows a perspective view of the mobile phone case having a mirrored surface of another embodiment of the present invention.

FIG. 13 shows a perspective view of the mobile phone case having a mirrored surface of another embodiment of the present invention.

FIG. 14 shows a perspective view of the mobile phone case having a mirrored surface of another embodiment of the present invention.

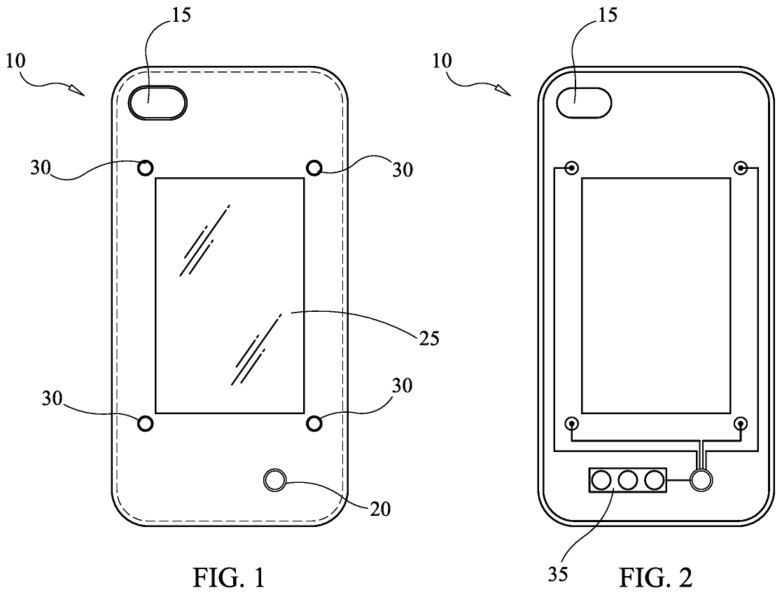

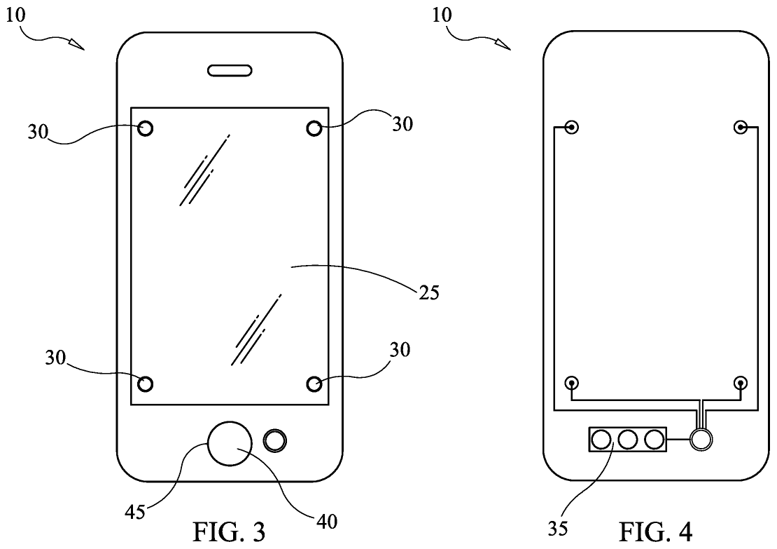

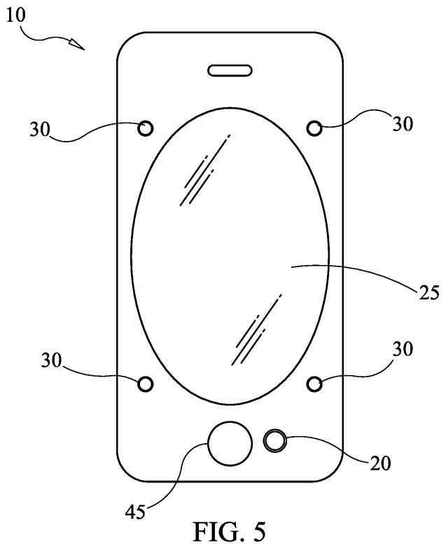

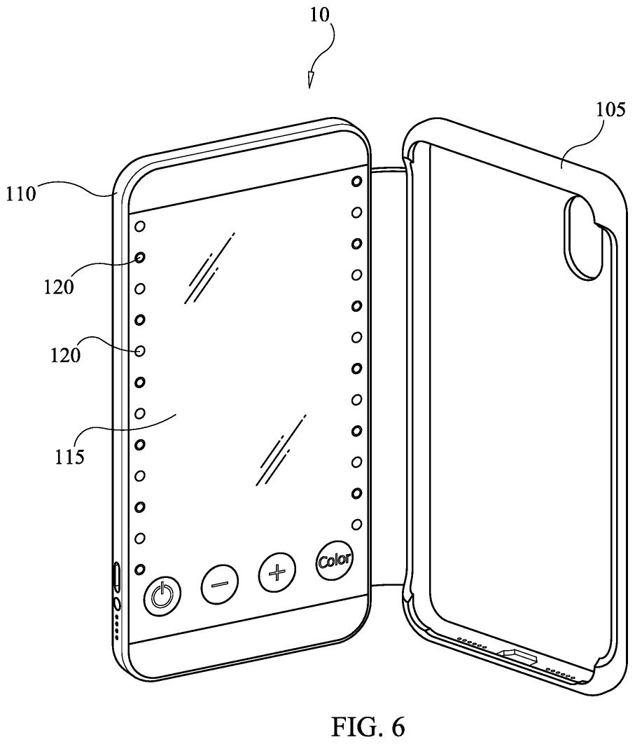

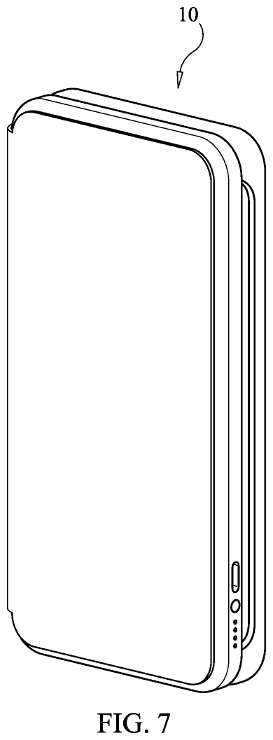

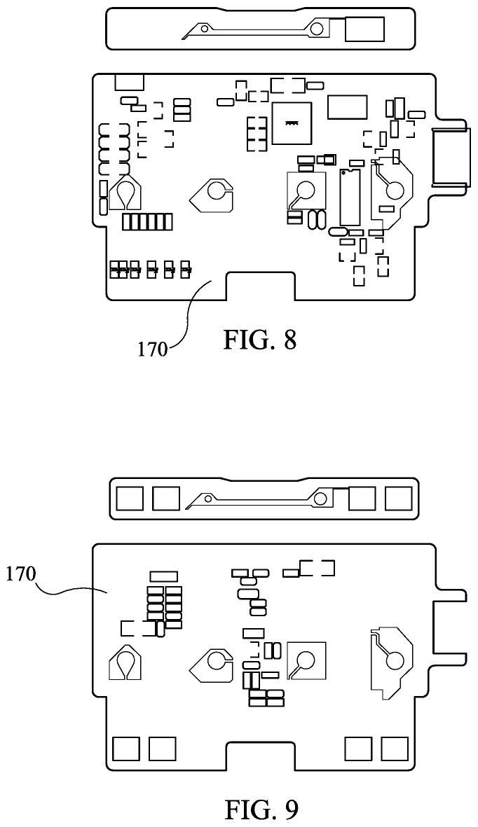

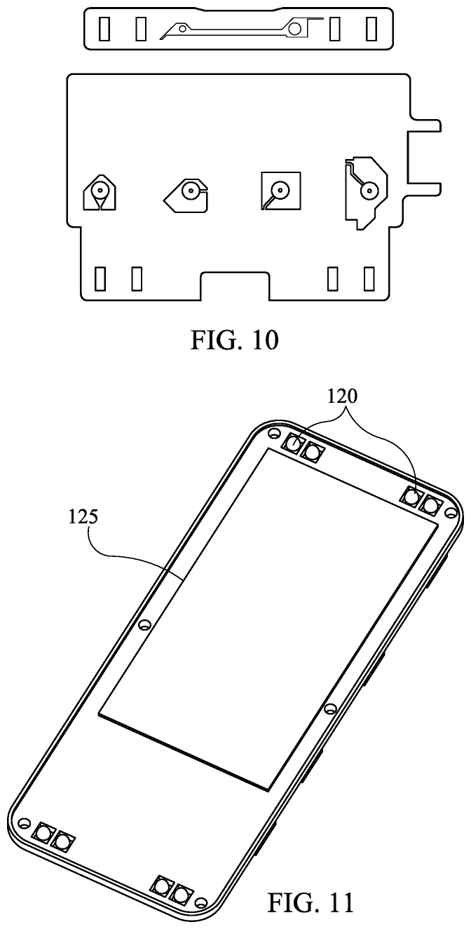

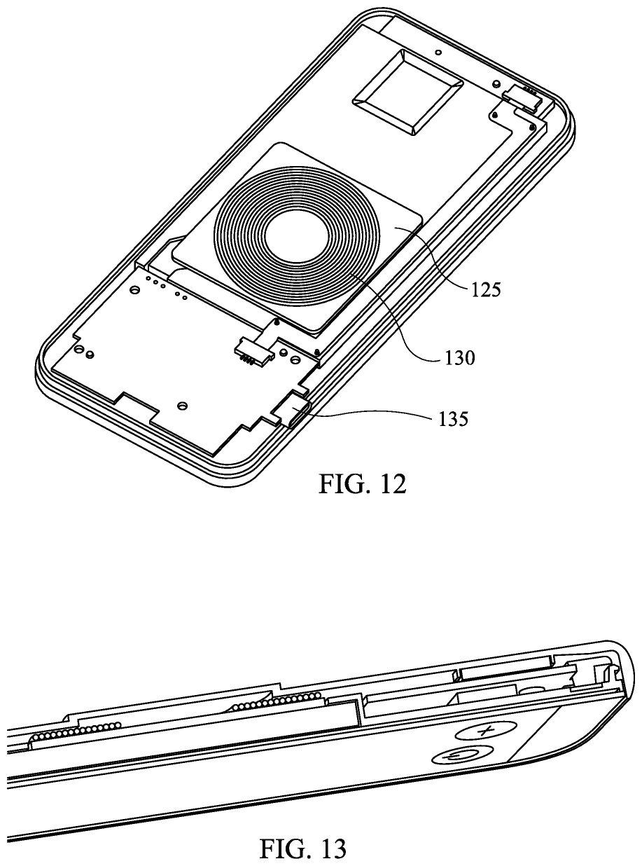

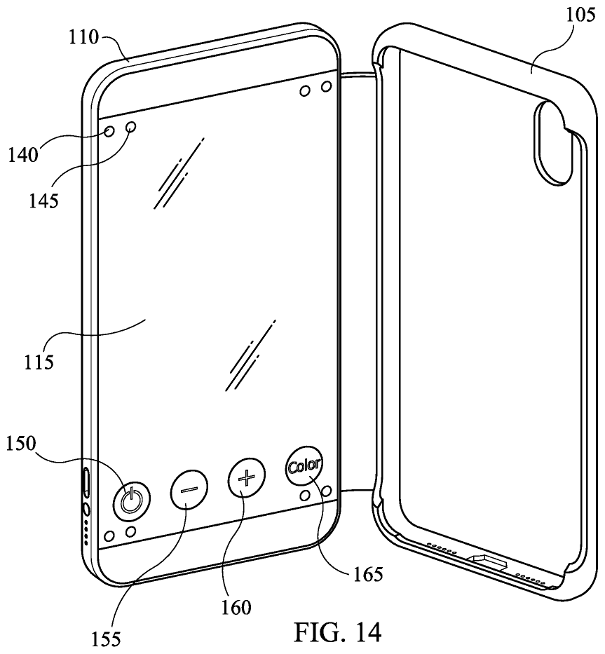

### DETAILED DESCRIPTION OF THE INVENTION

While this invention is susceptible of embodiments in many different forms, there are shown in the drawings and will herein be described in detail, preferred embodiments of the invention with the understanding that the present disclosure is to be considered as an exemplification of the principles of the invention and is not intended to limit the broad aspect of the invention to the embodiments illustrated.

The present invention is a mobile phone case 10 adapted to encase at least a portion of a mobile phone device. Preferably, the case 10 has a front opening allowing the viewing screen of the mobile phone to be viewed without removing the case. Preferably, the mobile phone case 10 has additional openings aligned with mobile phone components, such as a camera lens opening 15 and a speaker opening 20.

The mobile phone case 10 of the present invention includes a mirrored surface 25 disposed on a surface of the case 10. Preferably, the mirrored surface 25 is disposed on the rear surface of the case 10. The mirrored surface 25 may be any suitable shape, such as a generally rectangular shape, either with sharp or rounded corners, or a circular or oval shape, or any other shape which may be desirable.

The mobile phone case 10 of the present invention includes a plurality of lighting elements 30 disposed outside the perimeter of the mirrored surface 25 adapted to illuminate an object, such as the face of a user, to be reflected in the mirrored surface 25. In a preferred embodiment, the lighting elements 30 are a plurality of LEDs. Ideally, there are four to six LEDs spaced substantially evenly apart surrounding the mirrored surface 25 to provide even illumination.

The lighting elements 30 are operatively connected to a power source. The power source may be the same power source used by the mobile phone, i.e., the internal phone battery. Preferably, the power source is a separate power source 35 operatively connected to the plurality of lighting elements 30. For example, the power source 35 may be one or more button cell or rechargeable batteries. A power switch 40 is operatively connected to control power on and off to the lighting elements 30. It is understood that the case 10 of the present invention has sufficient depth and dimensions to house its components, such as electronic components, circuitry, and batteries.

In various preferred embodiments, the mobile phone case of the present invention additionally includes a dimmer control switch 45, which may or may not be combined with the power switch 40, operatively connected to the lighting elements 30. Thus, the user may adjust the brightness of the lighting elements 30 to a desired level. In certain embodiments, the case 10 includes a light sensor and circuitry which enables automatic dimming or brightness adjustment according to ambient light detected via the light sensor.

In certain preferred embodiments, a timer system is included and operatively connected to the lighting system. The timer system is adapted to turn the lighting elements off after a predetermined amount of time has passed since the lighting elements 30 were activated.

In another preferred embodiment, the mobile phone case 10 is formed of a receiving structure 105 which holds the phone, and a cover portion 110 which is foldable over the face of the phone. A mirrored surface 115 is disposed on an inner surface of the cover portion 110. Optional elements to hold the case 10 in a closed position may be included, such as magnets or other retaining elements.

The inner surface of the cover portion includes lighting elements, preferably LED lighting elements 120. The LED lighting elements 120 are disposed within a peripheral area around the perimeter of the mirrored surface 115 and are positioned and adapted to illuminate an object to be reflected in the mirror 115, such as the face or portion thereof of a user. The peripheral area may include an area that is outside of the perimeter of the mirror 115, or it may include a region interior to the perimeter of the mirror. Thus, the LED's 120 may be positioned on or through holes in the mirrored surface itself. Alternatively, the LED's 120 may emit light through a portion of the mirror 115 which has areas that are more translucent or transparent than other areas, such as by eliminating a silver coating on the back surface of the mirror 115.

The cover portion 110 preferably includes a power source, such as a rechargeable battery 125, operatively connected to the lighting elements 120. Optionally, a wireless recharging coil 130 is operatively positioned with respect to the rechargeable battery 125, and adapted to recharge the battery 125. A port, such as a USB port 135, may be optionally provided to recharge the battery 125. Furthermore, a charge indicator is optionally included to indicate when the rechargeable battery 125 is being charged, or when it has been fully charged, or both.

When the cover 110 is folded backwards all the way to the back part of the receiving structure, the recharging coil 130 is optionally adapted to charge a second battery in a phone inside the receiving structure. The same recharging coil 130 optionally may be adapted to provide a charge to a second phone or other rechargeable device outside of the case.

In various preferred embodiments, the LED elements 120 may be arranged in pairs of LED elements. A first LED element 140 of each pair may be a warmer color, such as 2000 K-2900 K, and a second LED element 145 of each pair may be a cooler color, such as in the range of 3000 K-7000 K. While these LED elements 120 may be in pairs, there may also be different numbers of each and they may be arranged in any suitable manner.

In certain preferred embodiments, the pairs of LEDs 120 may be disposed so that each pair is close to a corner of the mirrored surface 115 in order to evenly illuminate a reflected object. In various embodiments, one or more diffusing elements such as diffusing tubes may be included to diffuse light emitted from one or more of the lighting elements 120. Thus, the light emitted by the LED's 120 is optionally spread out for more even illumination.

The LED 120 elements are operatively connected to a power switch 150 in the cover 110, and preferably to a dimmer switch or set of dimmer buttons 155 and 160 within the cover 110. Ideally, the LED elements 120 are also operatively connected to a toggle switch or button 165 which can alternately operate warmer LED elements 140 and cooler LED elements 145, or both. A single switch or button 165 may serve to toggle power to both types of LEDs, warmer ones, cooler ones, and off. Alternatively, separate power button and toggle button may be used. As used herein, the terms button and switch are used interchangeable to mean any suitable element to be used as either by the user. Such buttons maybe be in an area separate from the mirrored surface 115, or they may be part of the surface of the mirror 115, having appropriate backings or sensors for functionality, as is known in the art.

In various embodiments, the buttons, such as power, dimmer, toggle, can be either disposed outside of the mirrored surface on the inner surface of the cover portion, on the mirrored surface itself as sensor buttons, or touch sensor buttons, or in any suitable position and arrangement. A PCB 170 may be included within the cover 110 to control the LED elements 120, buttons, power source, and recharging coil, or any subset thereof.

While specific embodiments have been illustrated and described, numerous modifications come to mind without significantly departing from the spirit of the invention and the scope of protection is limited by the scope of the accompanying claims.

What is claimed is:

1. A mobile phone case comprising:
a receiving structure adapted to encase at least a portion of a mobile phone device,
a mirrored surface disposed on a surface of said mobile phone case,
a plurality of lighting elements disposed outside the perimeter of said mirrored surface adapted to illuminate an object to be reflected in said mirrored surface, and
a power source operatively connected to said plurality of lighting elements.

2. The mobile phone case according to claim 1, wherein said power source is used to power a mobile phone device.

3. The mobile phone case according to claim 1, wherein said power source is distinct from a mobile phone device power source.

4. The mobile phone case according to claim 3, wherein said plurality of lighting elements comprises a plurality of LED lights.

5. The mobile phone case according to claim 4, wherein said plurality of lighting elements comprises at least four LED lights.

6. The mobile phone case according to claim 5, further comprising a power switch operatively connected to said LED lights.

7. The mobile phone case according to claim 6, further comprising a dimmer control switch operatively connected to said LED lights.

8. The mobile phone case according to claim 6, further comprising a light sensor and circuitry, wherein said circuitry effects a degree of dimming of said LED lights according to detected ambient light via said light sensor.

9. The mobile phone case according to claim 6, wherein said mirror is mounted to a rear surface of said mobile phone case.

10. The mobile phone case according to claim 6, further comprising a timer system adapted to turn said lighting elements off after a predetermined amount of time since said lighting elements were turned on.

11. A mobile phone case comprising:
a receiving structure adapted to encase at least a portion of a mobile phone device,
a cover foldably attached to said receiving structure and adapted to fold over said receiving structure,
a mirrored surface disposed on an inside surface of said cover,
a plurality of lighting elements disposed within a peripheral area of said mirrored surface adapted to illuminate an object to be reflected in said mirrored surface, and
a power source operatively connected to said plurality of lighting elements.

12. The mobile phone case according to claim 11, wherein said power source is a rechargeable battery.

13. The mobile phone case according to claim 12, wherein said rechargeable battery is operatively connected to a wireless recharging coil.

14. The mobile phone case according to claim 13, wherein said plurality of lighting elements comprises a plurality of LED lighting elements.

15. The mobile phone case according to claim 14, wherein said plurality of LED lighting elements comprises a first set of LED elements which emit a first warm color of light, and a second set of LED elements which emit a second cooler color of light which is cooler than said first warm color.

16. The mobile phone case according to claim 14, wherein said LED elements comprise a
first pair of LED elements comprising a first LED element adapted to emit light in the range of 2000 K-2900 K, and a second LED element adapted to emit light in the range of 3000 K-7000 K,
a second pair of LED elements comprising a first LED element adapted to emit light in the range of 2000 K-2900 K, and a second LED element adapted to emit light in the range of 3000 K-7000 K,
a third pair of LED elements comprising a first LED element adapted to emit light in the range of 2000 K-2900 K, and a second LED element adapted to emit light in the range of 3000 K-7000 K, and
a fourth pair of LED elements comprising a first LED element adapted to emit light in the range of 2000 K-2900 K, and a second LED element adapted to emit light in the range of 3000 K-7000 K.

17. The mobile phone case according to claim 16, wherein said mirrored surface is substantially rectangular in shape, and wherein said first pair of LED elements is disposed close to a first corner of said mirrored surface, said second pair of LED elements is disposed close to a second corner of said mirrored surface, said third pair of LED elements is disposed close to a third corner of said mirrored surface, and said fourth pair of LED elements is disposed close to a fourth corner of said mirrored surface.

18. The mobile phone case according to claim 17, where said LED elements are operatively connected to a power switch and a dimmer switch or pair of dimmer switches disposed within said cover.

19. The mobile phone case according to claim 18, further comprising a toggle switch operatively connected to said LED elements adapted to alternately turn on said first LED elements and said second LED elements.

20. The mobile phone case according to claim 19, wherein said cover is adapted to fold in an open position to a back side of said receiving structure, and said charging coil is adapted to charge a rechargeable battery in a phone within said receiving structure when in said open position.
